(19) United States
(12) Patent Application Publication
(10) Pub. No.: US 2011/0210812 A1
(43) Pub. Date: Sep. 1, 2011

(54) HOLDING DEVICE FOR A CAST RESIN TRANSFORMER WINDING

(75) Inventors: Karl-Heinz Charwat, Weilheim (DE); Rudolf Hanov, Weilheim (DE)

(73) Assignee: SIEMENS AKTIENGESELLSCHAFT, Muenchen (DE)

(21) Appl. No.: 13/127,272

(22) PCT Filed: Oct. 5, 2009
(86) PCT No.: PCT/EP2009/062910

§ 371 Date: May 3, 2011

(30) Foreign Application Priority Data
Nov. 3, 2008 (DE) 10 2008 055 882.6

(51) Int. Cl. H01F 27/26

(52) U.S. Cl. 336/210

(57) ABSTRACT

A holding device for fastening a cast resin transformer winding relative to a transformer core has a support element and a receiving element attached to a tie rod. By fastening the support element to the receiving element attached to the tie rod, a cast resin transformer winding can be fixed rigidly and precisely centered relative to a transformer core. By attaching the receiving element directly on the tie rod, circulation in the lower region of the cast resin transformer winding or of an insulating cylinder also attached to the support element is ensured and thereby the thermal properties of a cast resin transformer winding produced in this way are improved. Furthermore a modular and thus simple design of the cast resin transformer is possible due to the possibility of connecting the receiving element to the tie rod by way of the support element.

The invention relates to a holding apparatus for attachment of a cast-resin transformer winding to, by means of a supporting element, relative to a transformer core. The invention furthermore relates to a specifically designed tie rod and to a supporting element, which corresponds thereto, for holding a cast-resin transformer winding.

One difficulty which occurs regularly during the production of cast-resin transformers is that the windings must be attached relative to the transformer core which runs within the windings. Furthermore, external influences and forces, for example those during transportation, must not lead to any change in the relative position of the windings with respect to the transformer core.

For this reason, the windings are permanently attached relative to an upper and lower yoke of the transformer core by means of suitable fixing elements. This is accomplished in particular by means of supporting components which are composed of plastic, generally in the form of elongated blocks. For example, DE 201 05 608 U1 describes a supporting apparatus for an electrical component in the form of a coil. According to the abovementioned utility model document, a cuboid elongated block is wedged into a corresponding component in such a way that the winding is fixed and centered relative to the transformer core.

Furthermore, a fixing apparatus for an electrical winding according to DE 10 2005 058 0119 B4 is known from the prior art, in which fixing apparatuses are integrated within a winding and allow the winding to be screwed directly to the lower yoke of the transformer core. This ensures that the winding is permanently fixed relative to the transformer core.

The solutions in the prior art have the disadvantage that the corresponding components in some cases adversely affect circulation of the surrounding medium in the bottom area of the winding, and relatively short creepage paths result because of the direct connection between the windings and/or the transformer core.

The object of the present invention is therefore to avoid the disadvantages of the prior art and to provide a holding apparatus for attachment of a cast-resin transformer winding, which is simple to fit and at the same time does not adversely affect circulation of the air between the inner wall of the winding and the transformer core.

The abovementioned object is achieved by a tie rod as claimed in claim 1 in conjunction with a supporting element as claimed in claim 5, as well as a holding apparatus formed therefrom for attachment of a cast-resin transformer winding as claimed in patent claim 10.

According to the invention, a tie rod is provided which contains a holding element for attachment of a correspondingly designed supporting element. The fitting of a holding element directly to the tie rod as part of the transformer core avoids the need for the previously required supporting elements between the lower edge of the winding and the lower yoke of the transformer core, thus resulting in virtually unimpeded air circulation between the inner wall of the winding and the transformer core, in particular in the bottom area of the winding.

The fitting of the holding element directly to the tie rod ensures circulation in the lower area of the cast-resin transformer winding, and therefore improves the thermal characteristics of a cast-resin transformer produced in this way. Furthermore, the capability to connect the holding element on the tie rod to the supporting element allows the cast-resin transformer to be designed in a modular and therefore simple form.

The tie rod is advantageously designed such that the holding element has a central web and an attachment element, in which case the supporting element can be connected to the attachment element. The provision of an attachment element which can be connected to the supporting element results in a modular configuration for the attachment of the winding according to the present invention. Furthermore, only one corresponding attachment element needs to be designed such that it can be connected in a corresponding manner to the supporting element. To this extent, the holding element may be designed differently.

The holding element can advantageously be welded to the tie rod. In one advantageous refinement of the tie rod, the tie rod has a cutout such that the tie rod can be screwed to the transformer. The connection technique used at the moment, of hooking the tie rod into the upper and lower yokes, and axial bracing by means of the conventional supporting elements, is avoided by the abovementioned method. This likewise ensures secure attachment not only at the tie rod to the transformer core but, by means of the holding element and the corresponding supporting element, also secure and permanent fixing of the winding by means of the supporting element.

The object is likewise achieved by a supporting element for holding a winding in that the supporting element can be connected to a holding element which can be fitted to a tie rod, thus ensuring that the winding is held.

The supporting element advantageously has an elastic holding surface for holding the cast-resin transformer winding. The provision of a holding surface for holding the cast-resin transformer winding on the upper face of the supporting element makes it possible to absorb forces that occur in the windings. In one advantageous refinement of the supporting element, the supporting element has a cutout for holding an insulating cylinder. The insulating cylinder, which is conventionally arranged around a winding, can be positioned very precisely with respect to the relative position of the casting and therefore relative to the transformer core, by means of an appropriate cutout in the supporting element.

Furthermore, during the course of the production process, the insulating cylinder can be fixed easily and securely by means of the supporting element. For this purpose, the supporting element advantageously has a lock on the holding surface for attachment of the cast-resin transformer winding, and/or in the cutout for attachment of the insulating cylinder. The separation within the cutout of the supporting element and/or around the holding surface of the respective component to be locked in the form of a cast-resin transformer winding for the insulating cylinder can be locked quickly and easily by tightening the screw, in particular by means of a clamping connection, in a similar manner to a vise. The supporting element is advantageously composed of an electrically insulating material, thus preventing partial discharges and ensuring adequate insulation in this area of the cast-resin transformer.

The object is likewise achieved by a holding apparatus for attachment of a cast-resin transformer winding such that the supporting element is connected to a holding element which is fitted to a tie rod. The holding apparatus advantageously consists of two tie rods, each having a holding element, on the front face and rear face of one limb of the transformer core, with the cast-resin transformer winding being secured by two supporting elements which correspond to the holding elements.

The use of a tie rod, which is fitted to the front face and rear face of one limb of the transformer, and the holding elements connected to it allows the cast-resin transformer winding and, if appropriate, the insulating cylinder, to be fixed by two holding points in the lower area, thus ensuring that the windings are held in a very robust manner.

In one advantageous refinement of the holding apparatus, spacers are fitted above the cast-resin transformer winding, for attaching an insulating cylinder relative to the cast-resin transformer winding. In order to prevent the insulating cylinder from shifting because it is fixed solely in the lower area relative to the cast-resin transformer winding, appropriately designed spacers are positioned in the upper area of the cast-resin transformer winding such that touching and/or shifting of the insulating cylinder relative to the cast-resin transformer winding are/is precluded. In one advantageous refinement of the holding apparatus, the spacers are arranged distributed at equal distances around the cast-resin transformer winding.

Further advantageous refinements can be found in the dependent claims. The invention will be explained in more detail with reference to the exemplary embodiments which are illustrated in the following drawings, in which:

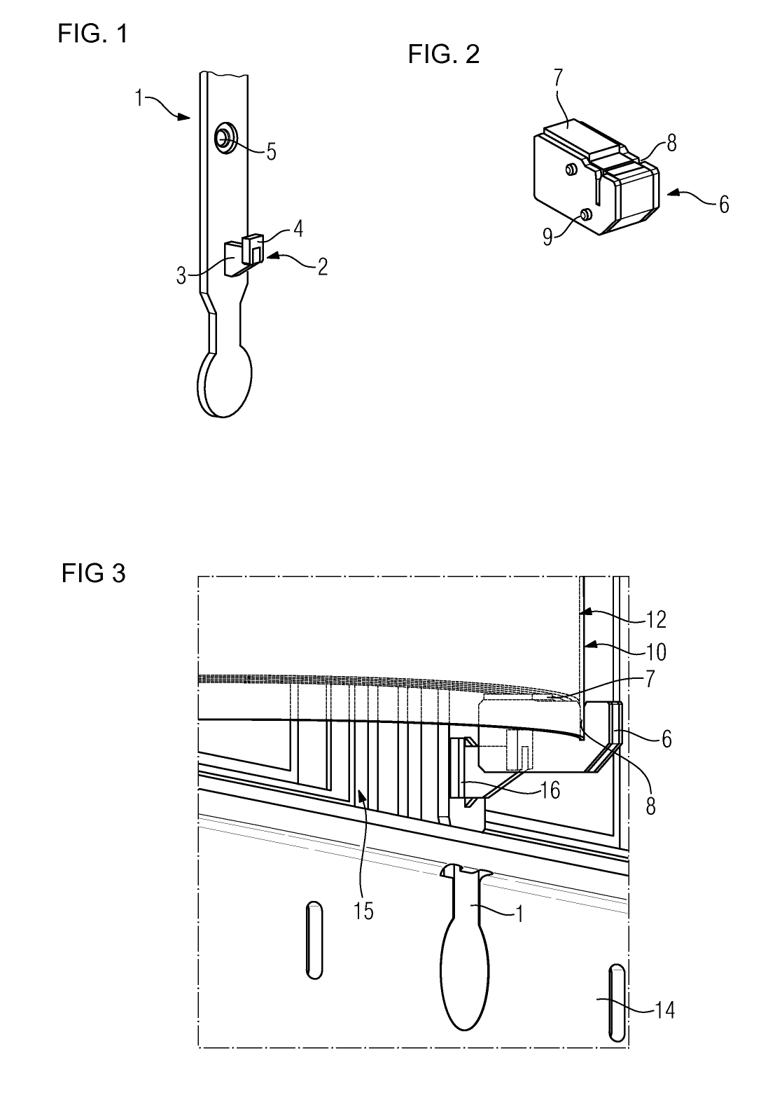

FIG. 1 shows a tie rod according to the invention with a holding element;

FIG. 2 shows a supporting element according to the invention with a cutout for attachment of an insulating cylinder;

FIG. 3 shows a detail view of a tie rod, fitted to a transformer core, with a holding element and a supporting element;

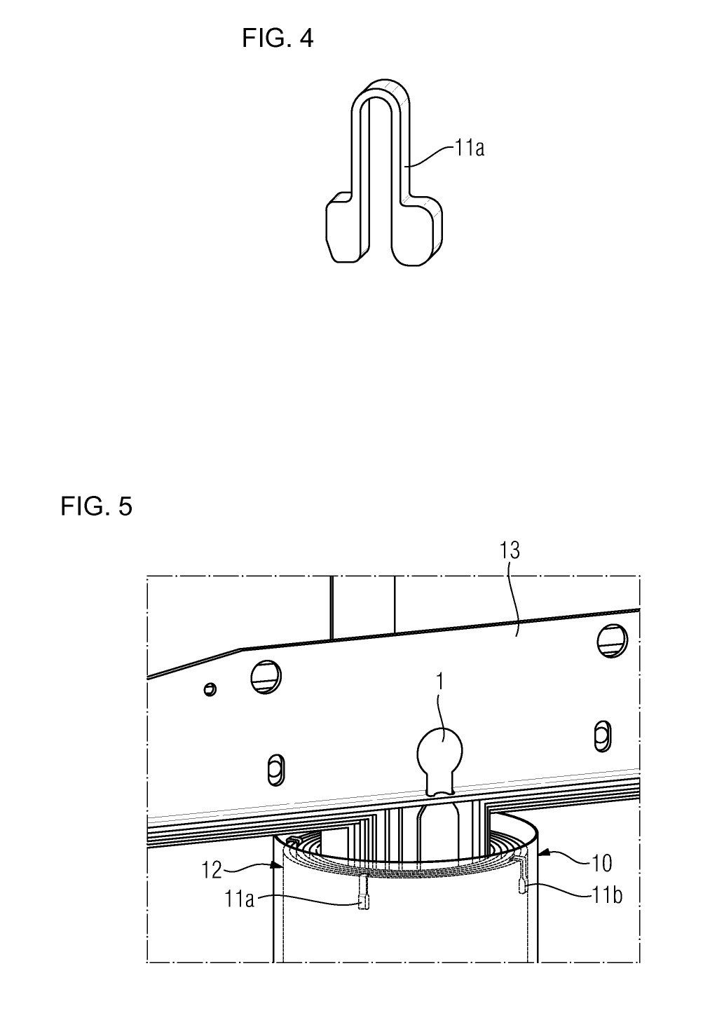

FIG. 4 shows a spacer; and

FIG. 5 shows a detail view of the upper yoke area with a tie rod on the transformer core and with two spacers.

FIG. 1 shows a tie rod 1 according to the invention with a holding element 2 which consists of a web 3 and an attachment element 4. Furthermore, the tie rod 1 has a hole 5 through which a screw can be passed and can be connected to the transformer core. The web 3 of the holding element 2 in the illustrated example is welded to the tie rod 1. Further connecting methods, such as screwing or adhesive bonding, are likewise included within the meaning of the present invention. The attachment element 4 in the example illustrated in FIG. 1 can be plugged onto the web 3 of the holding element 2.

FIG. 2 shows the supporting element 6, which has a contact surface 7 and a cutout 8. The cast-resin transformer winding 12 can be placed (not illustrated) on the contact surface 7. The internal separation of the cutout 8 can be reduced by means of a lock 9. At the same time, the supporting element 6 can be firmly connected to the holding element 2 by an appropriate lock 9. Furthermore, a lock 9 can be used to firmly connect the cast-resin transformer winding 12 to the contact surface 7.

FIG. 3 shows a partial view of the transformer core 15, in which the tie rod 1 is integrated. In the holding apparatus 16, the supporting element 6 is used to hold the cast-resin transformer winding 12 and the insulating cylinder 10. The tie rod 1 is likewise mounted in the transformer core 15 and in the lower yoke 14. As can be seen from FIG. 3, the distance between the cast-resin transformer winding 12 and the insulating cylinder 10 can be fixed precisely by fixing the distance between the cutout 8 and the supporting surface 7.

FIG. 4 shows a spacer 11a, by means of which the distance to the insulating cylinder 10 can be adjusted in the upper area of the cast-resin transformer winding 12. This is illustrated in FIG. 5, in which the spacers 11a, 11b are arranged in the upper area of the cast-resin transformer winding 12, thus ensuring the same distance between the cast-resin transformer winding 12 and the insulating cylinder 10.

1-14. (canceled)

15. A tie rod for connection of an upper yoke to a lower yoke of a transformer core, comprising:
a holding element for attachment of a correspondingly configured supporting element fitted to the tie rod.

16. The tie rod according to claim 15, wherein said holding element includes a central web and an attachment element, and wherein said attachment element is configured for connection to the supporting element.

17. The tie rod according to claim 15, wherein said holding element is welded to the tie rod.

18. The tie rod according to claim 15, wherein the tie rod has a cutout formed therein configured for screwing the tie rod to the transformer core.

19. A supporting element for holding a cast-resin transformer winding relative to a transformer core, wherein the supporting element is configured for connection to a holding element to be fitted to a tie rod, for ensuring that the cast-resin transformer winding is held.

20. The supporting element according to claim 19, wherein the supporting element is formed with an elastic holding surface for holding the cast-resin transformer winding.

21. The supporting element according to claim 19, wherein the supporting element is formed with a cutout for holding an insulating cylinder.

22. The supporting element according to claim 21, which is formed with a holding surface for holding the cast-resin transformer winding and which comprises a lock disposed on said holding surface for attachment of the cast-resin transformer winding and/or disposed in the cutout for attachment of the insulating cylinder.

23. The supporting element according to claim 19, wherein the supporting element is composed of an electrically insulating material.

24. A holding apparatus for fixing a cast-resin transformer winding relative to a transformer core, the holding apparatus comprising a supporting element connected to a holding element that is fitted to a tie rod.

25. The holding apparatus according to claim 24, which comprises two tie rods each having a respective said holding element, wherein said tie rods are fitted to a front face and a rear face of one limb of the transformer core, and the cast-resin transformer winding is secured by two said supporting elements corresponding to said holding elements.

26. The holding apparatus according to claim 24, which comprises spacers mounted above the cast-resin transformer winding, for attachment of an insulating cylinder relative to the cast-resin transformer winding.

27. The holding apparatus according to claim 26, wherein said spacers are equidistantly distributed around the cast-resin transformer winding.

28. The holding apparatus according to claim 24, comprising:
a tie rod for connection of an upper yoke of a transformer core and to a lower yoke of the transformer core, said tie rod carrying a holding element;
a supporting element connected to said holding element and holding a cast-resin transformer winding relative to the transformer core.
